(19) United States
(12) Patent Application Publication
(10) Pub. No.: US 2025/0079476 A1
(43) Pub. Date: Mar. 6, 2025

(54) BIPOLAR PLATE FOR AN ELECTROCHEMICAL SYSTEM

(71) Applicant: Reinz-Dichtungs-GmbH, Neu-Ulm (DE)

(72) Inventors: Claudia KUNZ, Ulm (DE); Thomas STÖHR, Laupheim (DE); Bernadette GRÜNWALD, Ulm (DE)

(21) Appl. No.: 18/821,910

(22) Filed: Aug. 30, 2024

(30) Foreign Application Priority Data
Sep. 1, 2023 (DE) 20 2023 105 024.7

(51) Int. Cl. H01M 8/0258; C25B 9/19; H01M 8/1004

(52) U.S. Cl. CPC H01M 8/0258; C25B 9/19; H01M 8/1004

(57) ABSTRACT

A bipolar plate for an electrochemical system comprising a first and second separator plate arranged adjacent to each other. Each separator plate has a first through-opening for passing a reaction medium, a second through-opening for passing a temperature control medium, an active region, and a distribution or collection region with flow channels separated by webs for guiding the temperature control medium between the second through-opening and the active region. The distribution or collection region also has a compensating region, where, in the unassembled state of the bipolar plate, the webs facing the adjacent separator plate are spaced apart from the adjacent plate except in an elastic contact region spaced from an outer edge of the compensating region in which a section of a web projects such that the section forms a contact surface with the adjacent separator plate.

### CROSS-REFERENCE TO RELATED APPLICATION

This application claims priority to German Utility Model Application No. 20 2023 105 024.7, entitled “BIPOLAR PLATE FOR AN ELECTROCHEMICAL SYSTEM”, filed Sep. 1, 2023. The entire contents of the above-identified application is hereby incorporated by reference for all purposes.

### TECHNICAL FIELD

The present disclosure relates to a bipolar plate for an electrochemical system. The electrochemical system may in particular be a fuel cell system, an electrochemical compressor, an electrolyser, or a redox flow battery. It can comprise a large number of such bipolar plates. Also disclosed is an electrochemical system comprising a plurality of such bipolar plates.

### BACKGROUND AND SUMMARY

Known electrochemical systems of the aforementioned type normally comprise a stack of electrochemical cells, which are separated from one another by bipolar plates. Such bipolar plates can be used, for example, to establish electrical contact with the electrodes of the individual electrochemical cells (such as fuel cells) and/or to electrically connect adjoining cells (series connection of the cells). Typically, the bipolar plates are formed of two joined individual plates, which are also referred to as separator plates within the scope of the present document. The single plates may be joined together in a materially bonded manner, for example by one or more welded joints, in particular by one or more laser-welded joints.

The bipolar plates or the individual plates can each have or form structures of the type explained below, which are set up, for example, for supplying the electrochemical cells arranged between adjacent bipolar plates with one or more media and/or for removing reaction products. The media can be fuels (e.g. hydrogen or methanol), reaction gases (e.g. air or oxygen) or temperature control media. Furthermore, the bipolar plates can be designed to conduct the waste heat generated during the conversion of electrical or chemical energy in the electrochemical cell and to seal the various media or temperature control medium channels against each other and/or from the external environment.

Moreover, the bipolar plates usually include at least one respective through-opening, through which the media and/or the reaction products can be conducted to the electrochemical cells arranged between adjoining bipolar plates of the stack or away therefrom. The electrochemical cells typically also each comprise one or more membrane electrode assemblies (MEAs). The MEAs may have one or more gas diffusion layers, which are usually oriented towards the bipolar plates and are formed, for example, as a metal or carbon fleece.

In particular, channels within the separator plates and thus the bipolar plate, which are separated from each other by webs, can be provided as structures for media supply and/or media guiding. The channels, which can be embossed in the form of grooves, for example, can provide flow paths for the typically liquid or gaseous media.

Typically, each separator plate has an active region with channels for guiding a reaction medium and/or reaction products along the outside of the bipolar plate. This active region is opposite an MEA. The active region can also be referred to as a flow field or comprise a flow field.

The active region is connected to one of the through-openings in a fluid-conducting manner via a so-called distribution region and is fed through this through-opening. Reaction media and/or reaction products can be fed from the active region via a further distribution region, which can also be referred to as a collection region, to a further through-opening for removal.

On the inner sides of two mutually-facing separator plates, which are surrounded by a respective bipolar plate, the above-mentioned channel-web structures of the flow field and of the at least one distribution region form complementary web-channel structures. These span a flow region for a temperature control medium guide in the interior of the bipolar plate.

The distribution regions also typically have defined separate channels. In the following, the channels on the outside of the bipolar plate in a distribution region are referred to as gas flow channels and the channels in the interior of the bipolar plate are referred to as temperature control medium flow channels.

When forming a ready-to-use stack, a membrane electrode assembly is provided between adjacent bipolar plates, which membrane electrode assembly, in the flow region, separates the channels for the passage of the reaction medium in a first bipolar plate from the channels for the passage of another reaction medium in a second bipolar plate, said second bipolar plate being separated from the first bipolar plate only by the membrane electrode assembly. The membrane electrode assembly, typically abbreviated as MEA, usually extends beyond the active region into the distribution region(s).

In their active region, MEAs usually comprise the actual proton-conducting membrane, electrodes applied to it and catalyst layers on which conductive and gas-permeable layers, so-called gas diffusion layers (GDLs), are applied. In its edge region, the MEA usually comprises a polymer-based film material that surrounds the active region in a frame shape and overlaps in a narrow overlap region with the materials forming the active region or a part thereof. In a stack of an electrochemical system, the MEA defines the spacing between the separator plates. At the same time, the gas diffusion layers (GDL) of the MEA exhibit relatively large fluctuations in thickness.

A space between bipolar plates is therefore usually provided in the thickness direction of the stack, so that there is sufficient space in the active region to accommodate the relevant section of the MEA on the one hand and just enough space for a predefined compression of this section of the MEA on the other. As a result, there is sometimes more space in the distribution regions than is absolutely necessary for their function. A thicker than average MEA in the active region therefore results in a large gap in the distribution regions, while a thinner than average active region of the MEA results in little or no gap in the distribution regions.

In conventional electrochemical systems, the bipolar plates are designed in such a way that their separator plates come to lie on top of each other in sections both in the active region and in the distribution regions and are welded together at least in sections in these regions. However, pressure fluctuations of the temperature control medium passing between the separator plates of a bipolar plate cause movements of the separator plates relative to each other and expose the connections between the separator plates of a bipolar plate, in particular welded connections in the distribution regions, to dynamic pressure fluctuations and loads. These can cause the welded joint to break. This applies in particular if the connections are already exposed to increased loads due to variations in the thickness of the MEAs.

As a result, undefined temperature control media flows can occur through the interior of the bipolar plate, which leads to pressure and thus efficiency losses. In addition, the separator plates as such can also become perforated in the region of the welded joints, which jeopardizes the operational capability and in particular the operational safety of the bipolar plate and the higher-level electrochemical system.

Other previously known solutions maintain the necessary height tolerance in the distribution region in the form of a gap between the two separator plates of a bipolar plate, but this means that no or only poor control of the temperature control medium is possible. This means that particularly poorly cooled zones can occur in the active region of the bipolar plate, which can lead to damage to the MEA and also result in efficiency losses.

One object of the present disclosure is therefore to provide a bipolar plate with which fluctuations in thickness of an MEA in an electrochemical system can be compensated while ensuring improved efficiency and operational reliability, preferably simultaneously achieving a defined distribution of the temperature control medium over the active region of the bipolar plate.

This object is solved at least in part by the subject-matter of the present disclosure.

A bipolar plate for an electrochemical system is proposed accordingly. The bipolar plate comprises a first separator plate and a second separator plate, which are arranged adjacent to each other in a direction perpendicular to the plate plane of the first and/or second separator plate. The first and second separator plates each have a first through-opening for passing a reaction medium through the separator plate, where the first through-openings are adjacent to each other in a direction perpendicular to the plate plane, for passing a reaction medium through the separator plate, and a second through-opening adjacent to the first through-opening in the plate plane for passing a temperature control medium through the separator plate. Furthermore, the first and second separator plates each comprise an active region with first structures for guiding the reaction medium along an outer flat side of the separator plate and second structures for guiding the temperature control medium along the inner side of the bipolar plate. These are also arranged adjacent to each other in a vertical direction or overlap with each other when projected orthogonally onto the plate plane.

In addition, the first and second separator plates each have at least one distribution or collection region, where the distribution or collection region(s) of the first and second separator plates are adjacent to one another in a direction perpendicular to the plate plane, with first structures for guiding the reaction medium between the first through-opening and the active region and second structures for guiding the temperature control medium between the second through-opening and the active region. The structures for guiding the temperature control medium in the distribution or collection region comprise temperature control medium flow channels that are separated from each other by webs that point in the direction of the other separator plate.

Furthermore, the at least one distribution or collection region of the first separator plate and/or the distribution or collection region of the second separator plate has at least one compensating region. In the unassembled state of the bipolar plate, in one, several or all of the at least one compensating regions, those webs which face the respective adjacent separator plate are spaced from the adjacent separator plate in the regions between mutually adjacent temperature control medium flow channels in a direction perpendicular to the plate plane. This applies with the exception that the compensation region has at least one free-standing elastic contact region at a distance from its outer edge, in which a section of a web protrudes in such a way that this section forms a contact surface with the adjacent separator plate.

The predominant spacing of the webs of one separator plate from the neighboring separator plate is used in the compensating region to compensate for height fluctuations of the MEA or GDLs. If an MEA or MEAs with GDLs of above-average thickness are installed, a gap remains in a stack of an electrochemical system even after the bipolar plate and the MEA have been installed and tensioned; if an MEA with GDLs of below-average thickness is installed, at least part of the retained gap is pressed into a stack of an electrochemical system when the bipolar plate and the MEA are installed and tensioned. The gap is usually designed in such a way that it can also compensate for very thin GDLs.

At a distance from its outer edge, however, the compensating region also has at least one free-standing clastic contact region in which a section of a web projects in such a way that this section forms a contact surface with the adjacent separator plate. The at least one elastic contact region is usually designed in such a way that it has at least one elastic compression component, so that after installation and tensioning it can deform reversibly with normal operational pulsation of the temperature control medium. After installation and tensioning of the bipolar plate and a rather thinner MEA in a stack of an electrochemical system, the at least one elastic contact region exhibits both plastic and elastic deformation. If, on the other hand, a very thick MEA is also installed, there may only be elastic deformation. However, the elasticity of the contact regions not only enables height compensation for different MEA or GDL thicknesses, but also adaptation to the pressure pulsation.

Preferably, the contact surfaces of the elastic contact regions of one separator plate touch web sections of the other separator plate in such a way that the contact surfaces of the elastic contact regions and the web sections of the other separator plate form a fluid barrier inside the bipolar plate, around which the temperature control medium must flow. This can result in a steering effect for the temperature control medium, so that by suitably arranging the contact surfaces, the temperature control medium can be guided in a defined manner into the regions that would experience inadequate temperature control during operation without such guiding, thereby improving the efficiency of the electrochemical system.

The contact surfaces protrude from the web surface in the direction of the other separator plate and are in contact with the other separator plate before the bipolar plate is installed and tensioned in a stack of an electrochemical system. Even under normal operating conditions, i.e. after installation and tensioning, this contact is usually present. With very strong pressure pulses of the temperature control medium, the contact surfaces may also lift off from each other for a short time. It is advantageous if, within a compensating region, the webs of one of the separator plates are each free of material bonding with the other separator plate. The elastic contact elements therefore even make it possible to dispense with weld seams connecting the separator plates. As a result, these cannot tear open, especially if the separator plates are perforated locally. This increases operational safety.

The elastic contact region for one, several or all of the elastic contact regions can have an elongated shape, a rounded-elongated shape, a round shape or a free form when viewed from the plate plane of one of the separator plates. If there are several elastic contact regions in a distribution or collection region, these can have different shapes. In particular, the choice of a specific shape of the elastic contact region can be adapted to the available installation space, and the specific shape can also influence the elasticity of an elastic contact region. For example, round elastic contact regions can be used in regions where less fluid steering is required, while the other shapes mentioned, especially the elongated shapes, can be used for steering.

When viewed from above the plate plane of a separator plate, the one compensating region or one of the several or all compensating regions as a whole—including the elastic contact regions contained therein—occupies an area FA. The total area of all contact regions contained therein is designated as FKges. The ratio of these two areas is FKges≤0.2 FA, optionally FKges≤0.1 FA. The elastic contact regions therefore only take up a fraction of the compensating region. This results in a large region of the compensating region in which temperature control medium is present or can flow between the two separator plates, optionally also between the mutually-facing webs.

The contact surfaces of the elastic contact regions usually only make up part of the surface of the elastic contact regions. When viewed from above the plate plane of a separator plate, the total area of the contact surfaces contained in one or a specific one of the several or all compensating regions can be determined as FBges. The ratio of the area of the one or one of the several or all compensating regions FA and the contact surface is FBges≤0.05 FA, optionally FBges≤0.03 FA, as defined above. This applies to the uninstalled and installed state.

It has been found that particularly good fluid steering of the temperature control medium can be achieved if one, several or all of the elastic contact regions have an elongated or a rounded-elongated shape when viewed from above the plate plane of one of the separator plates and have their longitudinal axis extend at a non-zero angle α to the longitudinal axis of the webs from which they protrude in the respective elastic contact region. Angles α with 15°≤α≤90° or 20°≤α≤60° may be particularly advantageous. In the case of non-rectilinear webs, the longitudinal axis can be understood as the centerline of two tangents, wherein the tangents touch the straight flank sections or inflection points of the web flanks on both sides of the web where a web flank has the smallest distance to the respective elastic contact region.

While in the active region of a bipolar plate the channels of both separator plates usually run essentially parallel, it is advantageous for a targeted distribution of the media over the entire width of the active region if in the distribution and/or collection region the gas channels of one separator plate extend at an angle to the gas channels of the other separator plate of the bipolar plate, as a result of which the temperature control medium flow channels of both separator plates inside a bipolar plate do not run parallel to each other. For example, the temperature control medium flow channels of one of the separator plates and the temperature control medium flow channels of the other separator plate can extend at least in sections at an angle of 15°≤δ≤90° to each other, optionally 20°≤δ≤60°. This already significantly contributes to distributing the temperature control medium over the entire width of the active region. Both for sufficient support of the contact surface(s) of the at least one elastic contact region on the other separator plate and for defined guidance of the temperature control medium, it is advantageous if one, several or all of the elastic contact regions of one of the separator plates and a web of the distribution or collection region of the other separator plate are positioned, in orthogonal projection to the plate plane of the first and/or second separator plate, at a very acute or even disappearing angle to each other. Angles γ for which γ≤30°, optionally γ≤20°, optionally γ≤10°, are particularly advantageous. The angle is determined along the longest extension of the elastic contact region in the case of an elongated elastic contact region as well as in the case of an elastic contact region that corresponds to a free form. On the side of the web, the longitudinal axis of the web is used, which is determined in the same way as the longitudinal axis of the web of the separator plates containing the elastic contact region, wherein the elastic contact region is projected orthogonally onto the other separator plate.

It can be particularly advantageous if, for one, several or all of the elastic contact regions, the clastic contact region has an elongated or rounded-elongated shape when viewed from the plate plane of one of the separator plates and its longitudinal axis runs essentially parallel to a web in the adjacent separator plate. This can result in a particularly large contact surface.

In embodiments, the web width is constant in the elastic contact region. Alternatively, the web width increases in the elastic contact region. The maximum web width in the region of the clastic contact region can thus be at least 30%, optionally at least 50%, optionally at least 100%, optionally at least 200% greater than the web width of this web outside an elastic contact region, for example in the region of the course of the web that has no elastic contact region and in which the web otherwise has its maximum width.

The elastic contact region can have a spring surface running at least in sections around the contact surface. The spring surface is preferably designed in such a way that it gives the elastic contact region its elasticity. For example, the spring surface can have a smaller pitch than the average pitch of the flank of the web in which the clastic contact region is arranged. For example, the pitch of the spring surface relative to the contact surface of the elastic contact region can span an angle β for which β≤30°, optionally β≤20°, optionally β≤15°.

The spring surface can completely encircle a contact surface. This is particularly preferable for rounded-elongated or rounded contact regions or for contact regions with a free form. Alternatively, in particular in the case of an elongated contact surface or an elongated elastic contact region, the spring surface can have an elongated shape at least in sections when viewed from above the plate plane of one of the separator plates and extend in its longitudinal axis essentially parallel to a web, in particular to the longitudinal axis of a web, in the adjacent separator plate. It is preferable if a corresponding elongated spring surface extends on both sides of an elongated contact surface.

In some examples, an elongated or rounded-elongated spring surface can extend between two closest temperature control medium flow channels in such a way that it connects their mutually-facing flank ends. This allows an entire web width to be provided with a barrier element.

It is also possible for a spring region of an elastic contact region to not only consist of a uniformly designed region. A spring region can also have at least two regions that have a different pitch relative to the contact surface bounded by the spring region. On the one hand, such regions with different pitches can follow one another in a continuous sequence, for example to achieve different elasticities in different regions. For this purpose, the width of the corresponding regions of the spring region may also be adjusted to avoid height steps. On the other hand, but not excluding the previous arrangement, these different regions can also be arranged relative to each other in such a way that one of these two regions optionally encircles the other regions, optionally completely encircles it. For example, a contact surface can be surrounded by a first of these regions of the spring region, optionally around its entire circumference. This first region of the spring region can then in turn be surrounded in sections or completely by the second area of the spring region. A progressive spring characteristic can be realized with these spring regions connected in series, especially if both spring regions have a different maximum deflection.

Furthermore, one of the two separator plates of a bipolar plate in the compensating region or compensating regions of the temperature control medium flow channels can be less deep than the outer flank of one or both of the two outermost temperature control medium flow channels, with the exception of the clastic contact regions. This makes it particularly easy to create the gap between the webs in the compensating region.

The present disclosure also relates to an electrochemical system comprising a plurality of bipolar plates according to any aspect described herein and MEAs, in particular a plurality of stacked bipolar plates and MEAs arranged therebetween.

Exemplary embodiments of the present disclosure will be explained below with reference to the accompanying schematic figures. Similar reference symbols can be used for comparable features across all figures.

### BRIEF DESCRIPTION OF THE FIGURES

FIG. 1 shows an electrochemical system with conventional bipolar plates or bipolar plates according to the present disclosure.

FIG. 2 shows a section of the electrochemical system shown in FIG. 1 with conventional bipolar plates.

FIG. 3A shows a partial plan view of a bipolar plate according to an example of the prior art.

FIG. 3B shows a partial cross-sectional view of the bipolar plate shown in FIG. 3A.

FIG. 3C shows a temperature control medium distribution of the bipolar plate shown in FIG. 3A.

FIG. 4A shows a partial plan view of a bipolar plate according to the present disclosure.

FIG. 4B shows a partial cross-sectional view of the bipolar plate of FIG. 4A along the sectional line B-B.

FIG. 4C shows a temperature control medium distribution of a bipolar plate according to the present disclosure.

FIG. 4D shows a partial cross-sectional view of the bipolar plate of FIG. 4A along the sectional line C-C.

FIG. 4E shows a detailed view of the cross-sectional view shown in FIG. 4D.

FIG. 5A shows an oblique view of a section of a distribution region of a bipolar plate according to the present disclosure.

FIG. 5B shows a detailed view of the section shown in FIG. 5A.

FIG. 6A shows an oblique view of a section of a distribution region of a further bipolar plate according to the present disclosure.

FIG. 6B shows a detailed view of the section shown in FIG. 6A.

FIG. 7 shows a partial top view of a distribution region of a further bipolar plate according to the present disclosure.

FIGS. 8A, 8B, and 8C show partial plan views of distribution regions of bipolar plates according to the present disclosure.

FIG. 9 shows an oblique view of a section of a distribution region of another bipolar plate according to the present disclosure.

### DETAILED DESCRIPTION

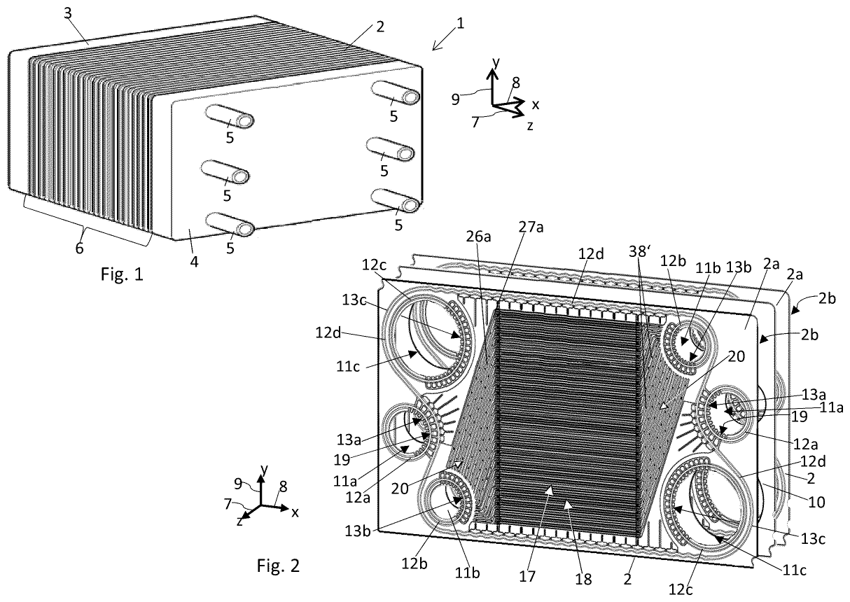

FIG. 1 shows an electrochemical system 1 with a plurality of identical bipolar plates 2. The bipolar plates 2 are arranged as an assembly in a stack 6 and are stacked along a z-direction 7. The bipolar plates 2 of the stack 6 are clamped between two end plates 3, 4. The z-direction 7 is also called stacking direction. In the present example, the system 1 is a fuel cell stack. Each two adjacent bipolar plates 2 of the stack 6 therefore enclose between them an electrochemical cell, which serves for example to convert chemical energy into electrical energy. To form the electrochemical cells of the system 1, a membrane electrode assembly (MEA) is arranged between adjacent bipolar plates 2 of the stack 6 (see e.g. FIG. 2). Each MEA typically contains a membrane, for example an electrolyte membrane. Furthermore, a gas diffusion layer (GDL) may be arranged on one or both surfaces of the MEA.

Alternatively, the system 1 shown in FIGS. 1 and 2 can also be designed as an electrolyzer, electrochemical compressor or redox flow battery. Bipolar plates 2 can also be used in these electrochemical systems. The structure of these bipolar plates 2 can correspond to the structure of the bipolar plates 2 described in more detail here, even if the media fed onto or through the bipolar plates 2 in an electrolyzer, in an electrochemical compressor or in a redox flow battery may differ in each case from the media used for a fuel cell system.

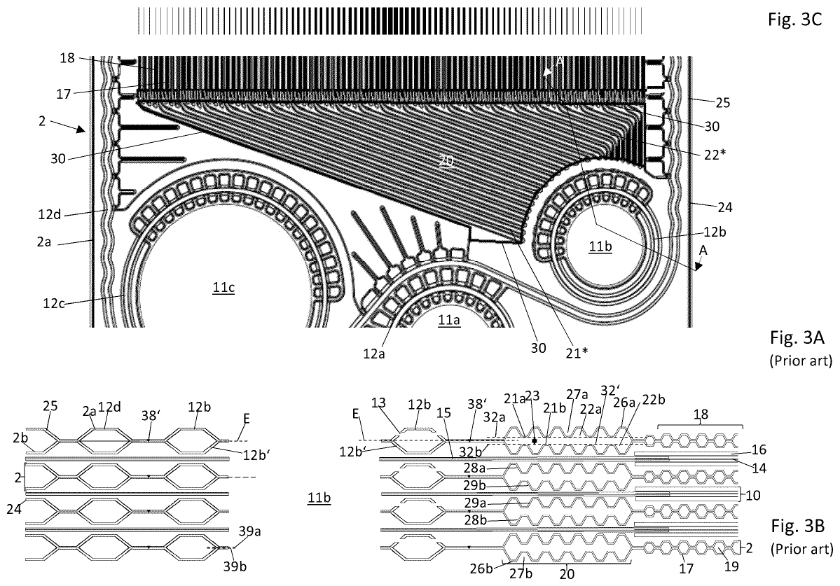

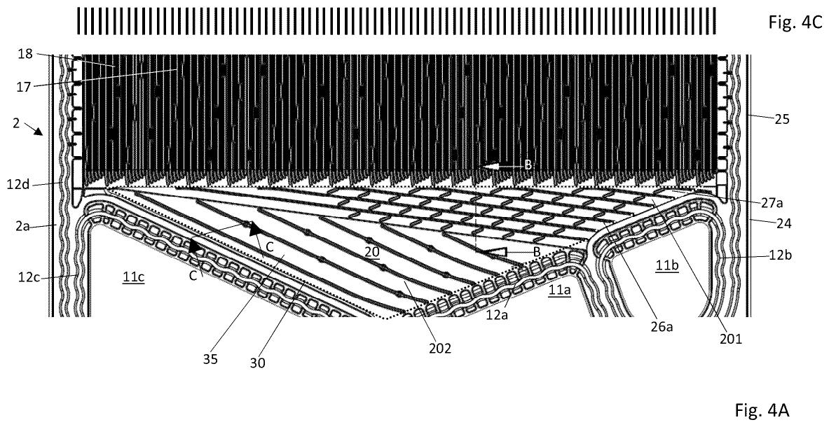

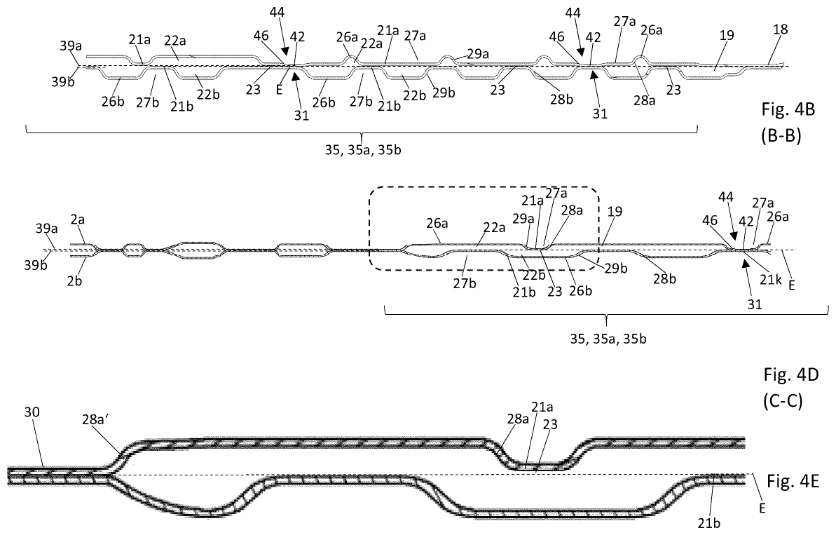

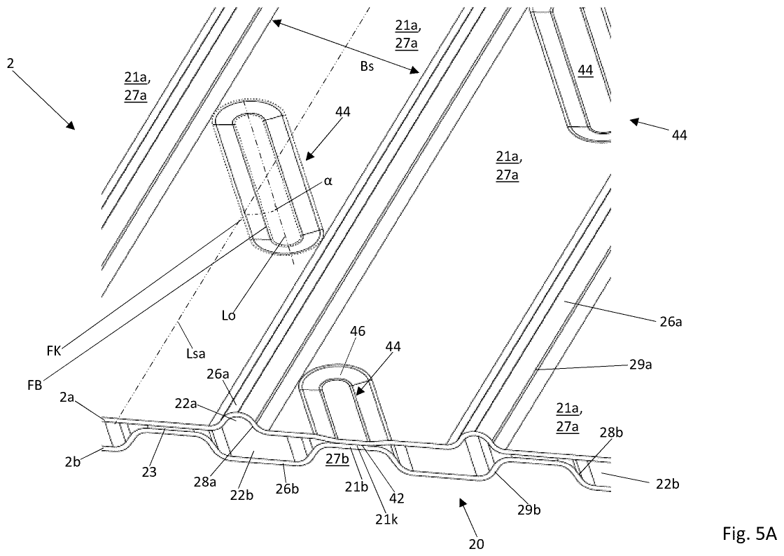

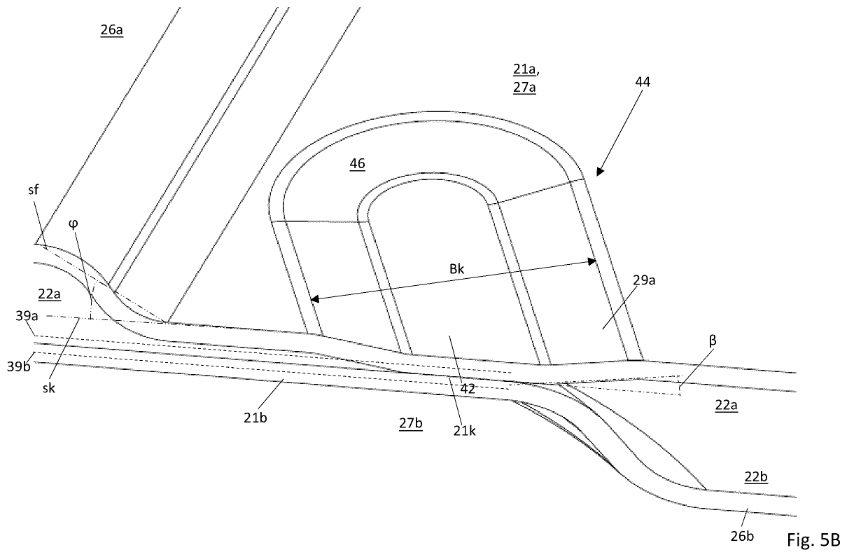

The z-axis 7 together with an x-axis 8 and a y-axis 9 defines a right-handed Cartesian coordinate system. The bipolar plates 2 each define a plate plane E (see FIGS. 3B and 4B) in which separator plates 2a, 2b (see FIG. 2), which form metallic layers of the bipolar plates 2, touch each other. The separator plates 2a, 2b also each form their own plate plane 39a, 39b in their non-formed regions (see FIGS. 3B, 4B, 5B and 6B), wherein the plate planes of both the bipolar plates 2 and the separator plates 2a, 2b are each aligned parallel to the x-y plane and thus perpendicular to the stacking direction or to the z-axis 7. The end plate 4 comprises a plurality of media connections 5, via which media can be fed to the system 1 and via which media can be discharged from the system 1. These media that can be supplied to and discharged from system 1 can include, for example, fuels such as molecular hydrogen or methanol, reaction gases such as air or oxygen, reaction products such as water vapor or depleted fuels or, if applicable, temperature control media such as water and/or glycol. In the case of an electrolyser, water is supplied to the stack and oxygen and hydrogen are discharged therefrom.

FIG. 2 shows a perspective view of two adjacent bipolar plates 2 of the system 1 of FIG. 1 as well as a membrane electrode assembly (MEA) 10 arranged between these adjacent bipolar plates 2 and known in principle from the prior art. The MEA 10 in FIG. 2 is largely concealed by the bipolar plate 2 facing the viewer. The bipolar plate 2 is formed from two separator plates 2a, 2b joined together by a material bond, of which only the first separator plate 2a facing the viewer is visible over a large area in FIG. 2, the first separator plate 2a covering the second separator plate 2b. The separator plates 2a, 2b may each be manufactured from a metal sheet, for example from a stainless steel sheet or a sheet made of a titanium alloy. The sheets can be coated or clad in sections or over their entire surface, for example by means of a corrosion-inhibiting and/or conductivity-enhancing coating. The separator plates 2a, 2b can, for example, be connected to each other by a material bond, for example welded, soldered or glued, and can in particular be connected by laser welded joints. The MEA 10 has, along its outer edge, a reinforcing edge at which the MEA is clamped between the two bipolar plates 2 in a fluid-tight manner.

The separator plates 2a, 2b have through-openings, which are aligned with each other and form through-openings 11a-c of the bipolar plate 2. When stacking a plurality of bipolar plates of the type of bipolar plate 2, the through-openings 11a-c together with aligned through-openings in the reinforcing edges of the MEAs 10 form lines that extend through the stack 6 in the stacking direction 7 (see FIG. 1). Typically, each of the through-openings formed by the passage openings 11a-c is in fluid connection with one of the ports 5 in the end plate 4 of the system 1. The lines formed by the through-openings 11a can be used, for example, to introduce temperature control medium into the stack or discharge it from the stack. In contrast, the lines formed by the through-openings 11b, 11c may be designed to supply fuel and reaction gas to the electrochemical cells of the fuel cell stack 6 of the system 1 and to discharge the reaction products from the stack 6. The media-guiding through-openings 11a-11c are each substantially parallel to the plate plane.

In order to seal off the through-openings 11a-c with respect to the interior of the stack 6 and with respect to the surrounding environment, the first separator plates 2a each have sealing arrangements in the form of port beads 12a-c, which are arranged in each case around the through-openings 11a-c and in each case completely surround the through-openings 11a-c. The second separator plates 2b have corresponding port beads for sealing the through-openings 11a-c on the rear side of the bipolar plates 2 facing away from the viewer of FIG. 2 (not shown).

In an electrochemically active region 18, the first separator plates 2a have a flow field 17 with structures for guiding a reaction medium along the front side of the separator plate 2a on their front side facing the viewer of FIG. 2. These structures are shown in FIG. 2 by a large number of webs and channels running between the webs and delimited by the webs. On the front side of the bipolar plates 2 facing the viewer of FIG. 2, the first separator plates 2a also each have at least one distribution region 20, which, depending on the direction of flow, can also be referred to as a collection region in the manner described above. The distribution or collection region 20 comprises structures that are configured to distribute, over the active region 18, a medium that has been conveyed into the distribution or collection region 20 from a first of the two through-openings 11b, and/or to collect or pool a medium flowing from the active region 18 towards the second of the through-openings 11b. In FIG. 2, the corresponding through-openings, which are used for the inlet or outlet of the same fluid that may have been modified in the course of the electrochemical reaction, are labeled with and without apostrophes, e.g. 11a and 11a′. The distribution structures of the distribution or collection region 20 are also shown in FIG. 2 by webs 26a, 26b and gas flow channels 27a, 27b extending between the webs 26a, 26b and bounded by the webs 26a, 26b. In general, the elements 17, 18, 20 can therefore be interpreted as media-guiding embossed structures.

In a conventional bipolar plate in FIG. 2, the separator plates in the region of the rear sides of the bases of the gas flow channels 27a, 27b lie directly on top of each other in the distribution regions and are supported against each other. The two separator plates are usually connected to each other at contact points in the distribution regions, in particular welded together, for example by means of short weld seams 38, as shown in FIG. 2.

The port beads 12a-12c of the example in FIG. 2 have passages 13a-13c, which are used for the passage of media through these sealing beads. For example, the passages 13a allow passage of temperature control medium between the through-opening 12a and the distribution region 20, so that the temperature control medium enters or is led out of the distribution region between the separator plates 2a, 2b. Furthermore, the passages 13b allow the passage of hydrogen between the through-opening 12b and the distribution region 20 on the upper side of the separator plate 2a. The passages 13c enable air, for example, to pass between the through-opening 12c and the distribution region 20, so that air enters the distribution region 20 on the underside of the lower separator plate 2b and is guided out from this distribution region 20. The through-openings 11a or the lines through the plate stack of the system 1 that are formed by the through-openings 11a are in each case fluidically connected to each other via a cavity 19 which is enclosed by the separator plates 2a, 2b. If necessary, this cavity 19 can be used to guide a temperature control medium through the bipolar plate 2, in particular for temperature control such as cooling, heating or keeping the temperature of the electrochemically active region 18 of the bipolar plate 2 constant.

The first separator plates 2a of the bipolar plates 2 of the stack 6 also each have a further sealing arrangement in the form of a perimeter bead 12d, which surrounds the flow field 17 of the active region 18, the distribution or collection region 20 and the through-openings 11b, 11c and seals these from the through-opening 11a, i.e. from the temperature control medium circuit and from the environment of the system 1. The second separator plates 2b each comprise corresponding perimeter beads 12d. In alternative plate designs, the perimeter bead can also include the temperature control medium openings and thus the entire temperature control medium circuit. The structures of the active region 18, the webs 21 and channels 22 of the distribution or collection region 20 and the sealing beads 12a-d are each formed in one piece with the separator plates 2a and molded into the separator plates 2a, e.g. in a lift stamping, roll stamping, deep drawing or hydroforming process. The same applies to the corresponding distribution structures and scaling beads of the second separator plates 2b.

Particularly in the case of a fuel cell, the separator plates 2a, 2b of the bipolar plate 2 may each be formed, for example, from a stainless steel sheet having a thickness of less than 100 μm. In the case of an electrolyser, it is possible to use either sheets made of a titanium alloy or sheets made of fully-coated stainless steel. The sheet thicknesses are usually greater in electrolyzers; for example, they can be 100-800 μm, 150-500 μm, optionally 200-300 μm. The bipolar plate 2 usually has a substantially rectangular shape, but it may also be round or oval, particularly in the case of electrolyzers.

FIG. 3A shows a partial top view of a bipolar plate 2 or its separator plate 2a according to an example of the prior art in the region of the through-openings 11a-11c, a distribution region 20, and a short section of the active region 18. The example differs from that in FIG. 2 in that there are no welded joints 38 in the distribution region 20 and the rear sides of the bottoms of the channels 27a, 27b do not rest on each other in the distribution region, but are arranged at a distance from each other within the boundary line 30.

FIG. 3A shows an example of the position of a sectional plane A-A with multiple bends. The sectional plane A-A is generally orthogonal to the plate planes E of the bipolar plate 2 and 39a, 39b of the separator plates 2a, 2b shown in FIG. 3B and thus in the z-direction of the stack in FIG. 1. It also extends in a region in which a distribution region 20 of the second separator plate 2b, which is concealed by the separator plate 2a in FIG. 3A, also extends. Thus, the distribution regions 20 of the separator plates 2a, 2b from FIG. 3A overlap in the sectional plane A-A. In addition, the rear sides or inner sides of the separator plates 2a, 2b, which are shaped to complement the respective distribution regions 20, are also opposite each other there, as can be seen from the partial cross-sectional view in FIG. 3B.

The identical bipolar plates 2 of the stack each comprise a first metallic separator plate 2a and a second metallic separator plate 2b, as in the example in FIG. 2. Structures for media conduction can be seen along the outer surfaces of the bipolar plates 2, here in particular in the form of webs 26a, 26b and gas flow channels 27a, 27b separated by the webs 26a, 26b. In particular, temperature control medium flow channels 22a, 22b are shown in the cavity 19 between adjacent separator plates 2a, 2b. Between the temperature control medium flow channels 22a, 22b, the two separator plates 2a, 2b have webs 21a, 21b which, unlike in the example in FIG. 2, are not in contact with each other. Between the planes 32a, 32b, in which the regions of the webs 21a, 21b closest to each other extend, there is a gap 23 in which the temperature control medium can flow freely. Flanks 29a, 29b and 28a, 28b extend between the webs or web roofs and channels or channel floors.

A membrane electrode assembly (MEA) 10, known for example from the prior art, is arranged in each case between adjacent bipolar plates 2 of the stack. The MEA 10 typically comprises a membrane 14, e.g. a catalyst-coated electrolyte membrane, and an edge section 15 connected to the membrane as well as at least one, in this case two, gas diffusion layers (GDL) 16. By way of example, the edge portion 15 may be connected to the membrane in a materially bonded manner, e.g. by an adhesive connection or by lamination. The gas diffusion layers 16 enable direct flow to the membrane over the greatest possible region of the surface of the membrane and can thus improve the transfer of protons via the membrane. The gas diffusion layers 16 may for example be arranged on both sides of the membrane in the active region 18 between the adjoining bipolar plates 2. The gas diffusion layers 16 may be, for example, formed from a fibre felt or comprise a fibre felt.

The membrane of the MEA 10 extends in each case at least over the active region 18 of the adjoining bipolar plates 2 and there enables a proton transfer via or through the membrane. However, the membrane does not extend into the distribution or collection region 20. The edge portion 15 of the MEA 10 serves in each case for positioning, attaching and sealing off the membrane between the adjoining bipolar plates 2. If the bipolar plates 2 of the system 1 are clamped in the stacking direction between the end plates 3, 4 (see FIG. 1), the edge section 15 of the MEA 10 can, for example, be pressed in each case between the port beads 12a-c of the respective adjacent bipolar plates 2 and/or in each case at least between the perimeter beads 12d of the adjacent bipolar plates 2 in order to fix the membrane 14 of the MEA 10 between the adjacent bipolar plates 2.

The two separator plates 2a, 2b are tightly welded together by means of weld seams 38′ only around the sealing beads, for example around the port bead 12b and along the outer edge 24, as can be seen from the sectional view in FIG. 3B.

The temperature control medium distribution of the bipolar plate shown schematically in FIG. 3C in FIG. 3A clearly shows, however, that the centrally located regions are very well supplied with temperature control medium, while the lateral edge regions, which lie approximately in the extension of the through-openings 11b, 11c, are only supplied with very little temperature control medium, as illustrated by the lines of different thicknesses.

The present disclosure has been designed to solve the above problems at least in part. The present disclosure is further explained with reference to FIGS. 4 to 7.

FIG. 4A shows a partial plan view of a bipolar plate 2 according to the present disclosure. FIGS. 4B and 4D show different partial cross-sectional views of the bipolar plate 2. FIG. 4C shows a temperature control medium distribution of the bipolar plate 2. FIG. 4E shows a detailed view of the cross-sectional view of FIG. 4D.

As in the examples of the prior art from FIGS. 2 and 3, the bipolar plate 2 is also formed here with a first separator plate 2a and a second separator plate 2b, which are arranged adjacent to one another in a direction perpendicular to the plate plane 39a, 39b of the first and/or the second separator plate 2a, 2b, as can be seen in the sectional view of FIG. 4B, which extends along the sectional line B-B of FIG. 4A. An explicit representation of the MEA or its reinforcing edge has been omitted in FIG. 4B, but the arrangement of the MEA relative to a bipolar plate essentially corresponds to that in FIG. 3B. In both separator plates 2a, 2b, two first through-openings 11b, 11c for passing a reaction medium through each of the separator plates and a second through-opening 11a, adjacent to the first through-opening in the plate plane 39a, 39b, for passing a temperature control medium through the separator plate 2a, 2b, are present in the section shown in a direction perpendicular to the plate plane 39a, 39b and are at least partially shown. As in FIG. 2, corresponding through-openings are also present adjacent to the opposite short end of the bipolar plate 2, but are not shown here.

Of the active region 18, only a short section with first structures 17 for guiding reaction medium along an outer flat side of the separator plate 2a is shown in both the plan view of FIG. 4A and the partial cross-sectional view of FIG. 4B; the second structures for guiding the temperature control medium along the inner side of the bipolar plate 2 are shown in the partial cross-sectional view of FIG. 4B.

The separator plates 2a, 2b in turn have at least one distribution or collection region 20 with first structures for guiding the reaction medium between the first through-opening 11b or 11c and the active region 18 and with second structures for guiding the temperature control medium between the second through-opening 11a and the active region 18, wherein the second structures for guiding the temperature control medium in the distribution or collection region 20 have temperature control medium flow channels 22a, 22b on the inner sides of the separator plates 2a, 2b, which are separated from one another by webs 21a, 21b and span a cavity 19 for guiding the temperature control medium inside the bipolar plate 2. Both the distribution or collection region 20 of the first separator plate 2a and the distribution or collection region 20 of the second separator plate 2b have a compensating region 35a, 35b, the outer boundary of which corresponds to the dashed boundary line 30 in FIG. 4A.

The partial cross-sectional view of FIG. 4B shows the state in which the two separator plates 2a, 2b are already connected to each other, but are not yet assembled in a stack of electrochemical cells. In the compensating region 35, the webs 21a, 21b facing the respective adjacent separator plate 2a, 2b between mutually adjacent temperature control medium flow channels 22a, 22b, are spaced from the adjacent separator plate in a direction perpendicular to the plate plane 39a, 39b. As in FIG. 3B, there is therefore a gap 23 in the z-direction, which allows the webs 21a, 21b to cross.

Excluded from this, however, is at least one free-standing elastic contact region 44, which is arranged at a distance from the outer edge 30 of the compensating region 35 and in which a section of a web, here a web 21a in the separator plate 2a lying on top, projects in such a way that it forms a contact surface 42 with the adjacent separator plate 2b. There are therefore contact surfaces 42 at some of the crossing points of the webs 21a, 21b of both separator plates 2a, 2b. The elasticity of the contact regions 44 enables height compensation for different MEA or GDL thicknesses, and also enables adaptation to the pressure pulsation, as will be described below.

Under normal operating conditions, these elastic contact regions 44 enable a better distribution of the temperature control medium over the width of the active region 18, as illustrated in FIG. 4C by the lines of equal width distributed over the entire width. Due to the elasticity, the clastic contact regions 44 spring during pulsation, so that the region of the respective contact surfaces 42 can change. The contact surfaces 42 can only lose contact in the event of extremely high surges of the temperature control medium. In contrast to the welded solutions of the prior art, this results in only a brief lift-off without damaging the separator plates or even tearing the plate material.

The contact surfaces 42 of the elastic contact regions 44 of the separator plate 2a touch web sections 21k of the other separator plate 2b, wherein the contact surfaces 42 of the elastic contact regions 44 and the web sections 21k of the other separator plate 2b touching the contact surfaces 42 preferably form a fluid barrier 31 inside the bipolar plate 2. The temperature control medium must flow laterally past the contact surfaces 42 and through the flow spaces spanned by the gap 23 to the fluid barrier.

In this example, the area bounded by the outer edge 30 is the entire area FA of the compensating region 35 under consideration. In the example of FIG. 4A, the distribution region 20 or compensating region 35 has two regions 201, 202 of different fluid routing, in which the elastic contact regions 44 are also designed differently as an example. The different design of the clastic contact regions could also originate from different bipolar plates.

FIG. 4D shows a partial cross-sectional view along the sectional line C-C from FIG. 4A. Finally, FIG. 4E shows a magnification of the region V from FIG. 4D, wherein the magnification in the z-direction is greater than that in the plate plane to clarify the height ratios. This detailed view clearly shows the gap 23 between the web 21a or its surface facing the lower separator plate 2b and the surface of the web 21b facing it, even if the view here shows the webs intersecting offset from one another in the plate plane. In particular, this surface of the web 21a is spaced from the plate plane E of the bipolar plate 2. The channel flank 28a′ facing the outer edge 30 of the compensating region 35 is higher than the channel flank 28a arranged inside the compensating region 35. In this compensating region 35, the temperature control medium flow channels 22a, with the exception of the elastic contact regions 44, are therefore less deep than the outer flank 28a′ of at least the two outermost temperature control medium flow channels 22a shown.

FIGS. 5A and 5B show an oblique view of the section 201 of a distribution region 20 of a bipolar plate 2 according to the present disclosure as well as an associated detailed view. While the flow cross-sections of the temperature control medium flow channels 22b and the gas flow channels 27b are comparable in the separator plate 2b that is arranged at the bottom, the separator plate 2a that is arranged at the top spans considerably more flow space for guiding the gas on the outer surface in the gas flow channels 27a than for guiding the temperature control medium in the flow channels 22a. In FIGS. 5A and 5B, the temperature control medium flow channels 22a and 22b in both separator plates 2a, 2b run at an angle to each other, the temperature control medium flow channels 22a of the first separator plate 2a are significantly narrower than the temperature control medium flow channels 22b of the second separator plate 2b. A gap 23 remains between the mutually-facing webs 21a, 21b between mutually adjacent temperature control medium flow channels 22a, 22b in large sections of the compensating region 35 in the direction perpendicular to the plate plane 39a, 39b. Although this gap is less than a quarter of the height of a temperature control medium flow channel 22a, 22b, it still allows the webs 21a, 21b to cross and provides a wide variety of flow paths for temperature control medium. Also to direct the flow of the temperature control medium, a plurality of elastic contact regions 44 are provided in those sections of a separator plate that form a bottom of a gas flow channel 27a on one surface of the separator plate and the web 21a between two temperature control medium flow channels 22a on its other surface. In these regions, a section 21k of a web 21a protrudes in such a way that it forms a contact surface 42 with the adjacent separator plate, in this case the separator plate 2b.

The elastic contact regions 44 shown in FIG. 5A all have a rounded-elongated shape. The longitudinal axis Lo of an exemplary contact region 44 runs at an angle α to the longitudinal axis Lsa of the web 21a in the corresponding elastic contact region 44, wherein α here—in plan view of the plate plane 39—is approximately 30°. In addition to the barrier effect of the elastic contact regions 44, this angled arrangement forces the temperature control medium to be steered in a targeted manner. In contrast to the example shown here, not all elastic contact regions 44 must have their longitudinal axes at the same angle α to the longitudinal axis of the associated webs; rather, it may be preferable for fluid guidance if different elastic contact regions 44 have different orientations.

In the section of the compensating region 35 shown in FIG. 5A, the web width Bs in the region of the elastic contact region 44 is constant and corresponds to the web width outside the clastic contact region 44. As a result of this and the only small height of the elastic contact region 44, the cross-section of the relevant gas flow channels 27a changes only slightly, so that the elastic contact regions 44 do not cause any significant pressure losses.

The elastic contact regions 44, which all belong to the same compensating region, each have an area FK. The areas FK can be added up to a total area FKges for an entire compensating region. Compared to the area of the relevant compensating region 35 (see FIG. 4A), however, this total area is very small, amounting to less than 10%. Similarly, the areas FB of the contact surfaces 42 of the contact regions 44 of a compensating region can be added up to a total area FBges. This results in an even smaller proportion of the area FA of the relevant compensating region 35, amounting to less than 3%. The aforementioned values can refer to the state of an uninstalled bipolar plate 2 or to a bipolar plate 2 installed in a stack 6 of an electrochemical system 1.

FIG. 5B shows that the elastic contact region 44 has a spring surface 46 running around the contact surface 42. With a slope relative to the contact surface β of approximately 10°, this spring surface 46 has a lower pitch sk than the average pitch of the flank of the neighboring web sf in the same separator plate 2a with a slope ϕ of approximately 32° relative to the contact surface. However, the slope of the flank, that is of straight flank section 29a, is significantly steeper and is approximately ε=60°.

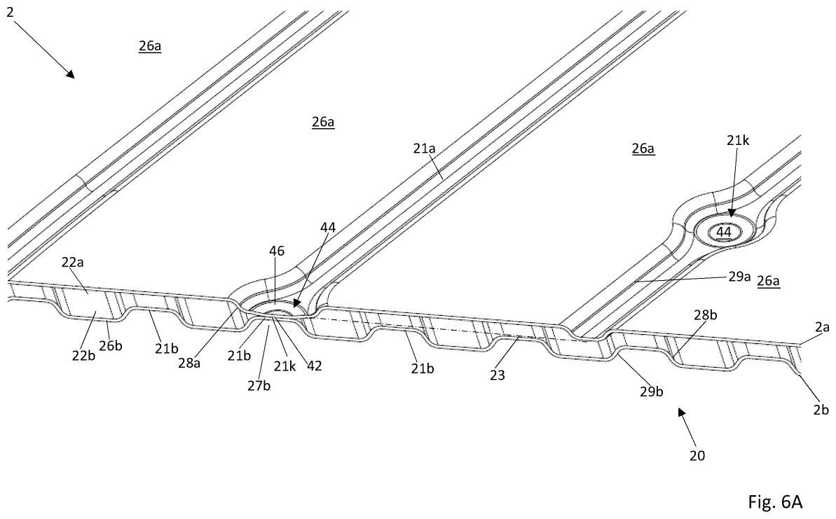

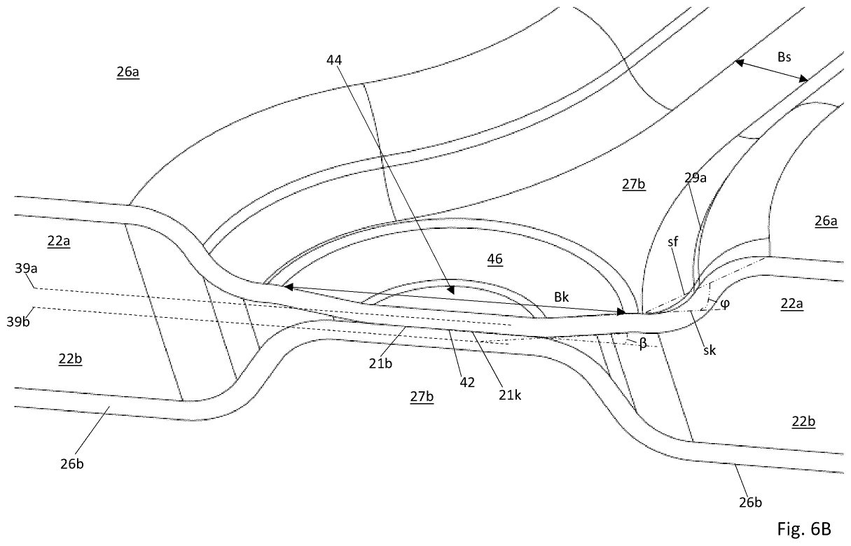

In FIG. 6A, an oblique view of another section 202 of a distribution region 20 is shown, which, however, could also belong to another bipolar plate 2 according to the present disclosure. FIG. 6B shows an associated detailed view. The elastic contact regions 44, which are shown in FIG. 6A, each have a round shape, as do the contact surfaces 42. The spring surfaces 46 surround the latter in a substantially circular shape. Compared with the webs 26a separating them, the gas flow channels 27a of the upper separator plate 2a have a width in the regions in which no clastic contact regions 44 are arranged which is only approximately a quarter of the width of the webs 27a separating them. Accordingly, the temperature control medium flow channels 22a are approximately four times as wide as the webs 21a separating them. However, the webs 21a widen in the region of the elastic contact region 44. There they have a maximum web width Bk that is almost 5 times as large as the web width Bs outside an elastic contact region 44, as is particularly clear in FIG. 6B. In FIG. 6B, the width Bk is only shown symbolically in the widest web region; it should actually extend orthogonally to the longitudinal axis of the web and thus parallel to Bk, but this is difficult to depict due to the oblique view.

The angle β, which the spring surface 46 makes with the plane of the separator plate or of the contact surface 42 is again approximately 10°, whereas the angle that the flank 29a makes with the contact surface 42 is approximately 25° and is therefore somewhat smaller than in the previous example.

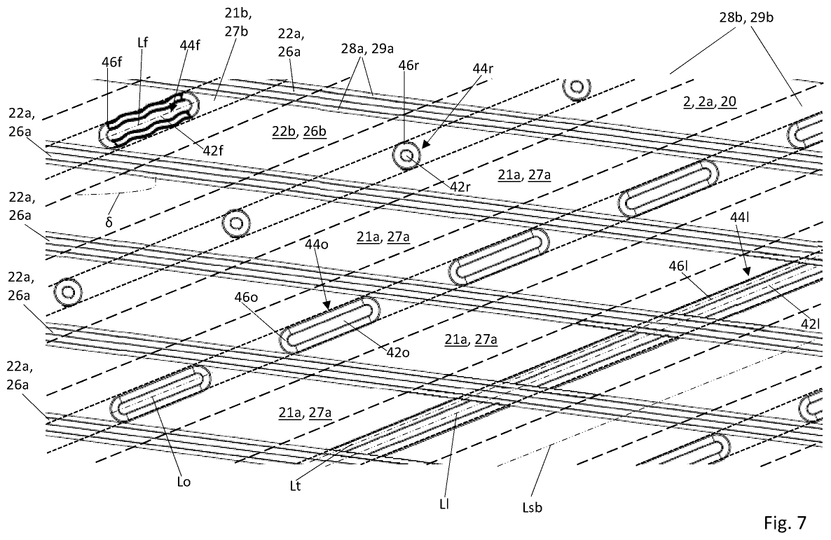

FIG. 7 shows a partial top view of a distribution region 20 of another bipolar plate 2 according to the present disclosure. On the one hand, various forms of elastic contact regions 44 are shown by way of example in a top view of the plate plane E or a view through the separator plate 2a. Both the elements that are located on the surface facing the viewer and those that are arranged in the cavity 19 or on the underside are provided with reference signs. On the one hand, a group of elastic contact regions 44l is provided, which extends in an elongated shape from the bottom left to the top right and in each case merges directly into the webs 21a separating the temperature control medium flow channels 22a. Groups of elastic contact regions 44o with a rounded-elongated shape are shown both on the far right and in the center, which also extend from the bottom left to the top right, but leave a small distance to the webs 21a separating the temperature control medium flow channels 22a. To the left of center, a group of elastic contact regions 44r is shown, which have a round shape and a clear distance from the webs 21a separating the temperature control medium flow channels 22a. Finally, an example embodiment of an elastic contact region 44f is shown at the top left, which has a free form.

In all the examples shown in FIG. 7, the elastic contact region 44 has a contact surface 42 and a spring surface 46 extending at least in sections around the contact surface 42. The spring surface 46o, 46r, 46f is designed in such a way that the spring surface 46o, 46r, 46f completely encircles the contact surface 42o, 42r, 42f. In the group of elastic contact regions 44l with an elongated shape, the spring surfaces 42l also have an elongated shape, at least in sections. These elongated spring surfaces 42l extend between two closest temperature control medium flow channels 22a in such a way that they connect their mutually-facing flank ends.

In FIG. 7, the gas flow channels 27a of the upper separator plate 2a run parallel to each other and from top left to bottom right, with an inclination of less than 10° to the horizontal. The temperature control medium flow channels 22a extend in the same direction on the rear side of the webs 26a, which separate the gas flow channels 27a and also run parallel and with the same inclination. The flanks between the webs and channels are each indicated by the reference sign 28a on the inner side of the bipolar plate 2 carrying the temperature control medium, or 29a on the gas-carrying outer surface of the bipolar plate 2.

On the other hand, FIG. 7 also shows the courses of the temperature control medium flow channels 22b in the separator plate 2b, which is at the bottom in this illustration, with dashed lines. The temperature control medium flow channels 22b (or webs 26b between the gas flow channels 27b) extend between the regions delimited by longer dashed lines, the corresponding webs 21b (or gas flow channels 27b) between the regions delimited by shorter dashed lines, and the flanks 28b or 29b between a longer dashed line and a shorter dashed line. These structures run from bottom left to top right. The temperature control medium flow channels 22a of the first separator plate 2a form an angle δ of approximately 150° with the temperature control medium flow channels 22b of the second separator plate 2b.

The elastic contact regions 44l run with their longitudinal axis Ll essentially parallel to the longitudinal axis Lsb of a web in the adjacent separator plate 2b, in this case both to the webs 21b separating the temperature control medium flow channels and to the webs 26b separating the gas flow channels. The longitudinal axis Lsb is only explicitly drawn for a web of the latter type. In principle, however, an acute angle between the two webs is also possible, but this should not exceed 30°. A comparable parallelism is also given here for the longitudinal axes Lo and Lf of the elastic contact regions 44o and 44f and the longitudinal axis Lsb. The longitudinal axes Lt of the spring surfaces 46 arranged on both sides of the contact regions 42f also run parallel to the longitudinal axes Lsb of the webs 21b and 26b.

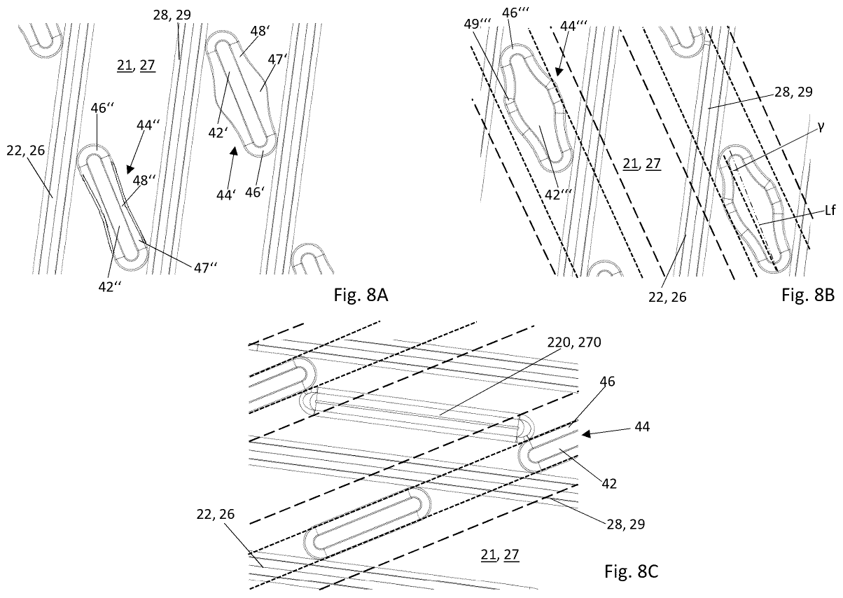

FIGS. 8A, 8B, and 8C show further embodiments of bipolar plates according to the present disclosure, wherein the elastic contact regions 44 in FIGS. 8A and 8B deviate from the aforementioned embodiments; in order to emphasize this deviating form the relevant reference signs are provided with dashes for differentiation. Both in FIG. 8A and in FIG. 8B, elastic contact regions 44′, 44″, 44′″ are formed in keyhole shape. In FIG. 8A, all elastic contact regions 44′, 44″ have in common that the contact surfaces 42′, 42″ have a rounded-elongated shape. The spring surfaces 46′, 46″ surrounding the contact surfaces 42′, 42″ each have a constant width along their rounded end regions. The elongated, lateral sections are designed differently. While the corresponding sections of the contact region 44′ initially form a narrow region 48′, which widens into a wide region 47′ and then tapers again essentially symmetrically into a narrow region 48′, the arrangement of the wide regions 47″ and the narrow regions 48″ is opposite in the elastic contact region 44″. Thus, in the elastic contact region 44′, a particularly high elasticity is achieved in the middle region, i.e. in the region with the narrow areas of the spring surface 44′, the elasticity thus increases from one end towards the middle, only to increase again towards the opposite end. With the spring surface 46″, on the other hand, a uniformity of elasticity is achieved over the entire elastic contact region 44′. The changing width of the elastic contact region 44′, 44″ with its protrusions or recesses can further contribute to steering the temperature control medium. The regions 47, 48 with different widths have different pitches as they connect planes of the same distance. FIG. 8A thus shows two different elastic contact regions 44′, 44″, in each of which a spring region 46 has at least two regions 47, 48 which have a different pitch relative to the contact surface 42 bounded by the spring region 46, the at least two regions 47, 48 following one another circumferentially.

In the clastic contact region 44′″, the contact surface 42′″ also has an approximate keyhole shape. The spring surface 46′″ runs around the contact surface 42′″ with an essentially constant width. However, the curved regions 49 have slightly less elasticity than the straight sections. The overall shape of the elastic contact region 44′″ with its projections or recesses serves on the one hand to make good use of the installation space within a temperature control medium web 21 and at the same time to additionally guide the temperature control medium around the clastic contact region 44′″.

In FIG. 8B, the different regions of the separator plate covered by the visible separator plate of the bipolar plate 2 are also shown with the same line patterns as in FIG. 7. Unlike in FIG. 7, for example, the webs and channels of the covered separator plate do not run parallel to the longitudinal axis Lf of the elastic contact regions 44′″, but at an acute angle γ, which is approximately 5° here.

FIG. 8C shows that the distribution region can also be designed with at least one temperature control medium intermediate channel 220, which is arranged, for example, partly in a web 21 between two temperature control medium flow channels 22. As in FIG. 7, the dashed lines indicate the different regions of the separator plate covered by the visible separator plate of the bipolar plate 2. Accordingly, the intermediate channel 220 runs in an region in which a temperature control medium flow channel, that is, the flanks delimiting the channel, also extends in the other separator plate. The intermediate channel 220 therefore extends the flow cross-section available for the temperature control medium in the corresponding region. At the same time, the structures of the intermediate channel 220 can also form additional flow guiding elements on the surface facing the viewer, i.e. an intermediate web or an additional barrier in the region of a gas flow channel 270. This also allows the direction of the gas flowing in this gas flow channel 270 to be influenced. The reference signs in FIG. 8C are given without assignment to the first or second separator plate in order to emphasize that the elastic contact regions 44 can in principle be arranged in an anode plate and/or in a cathode plate of a bipolar plate. However, if they are arranged in both separator plates, it is preferable if they are arranged in non-overlapping sections in the bipolar plate.

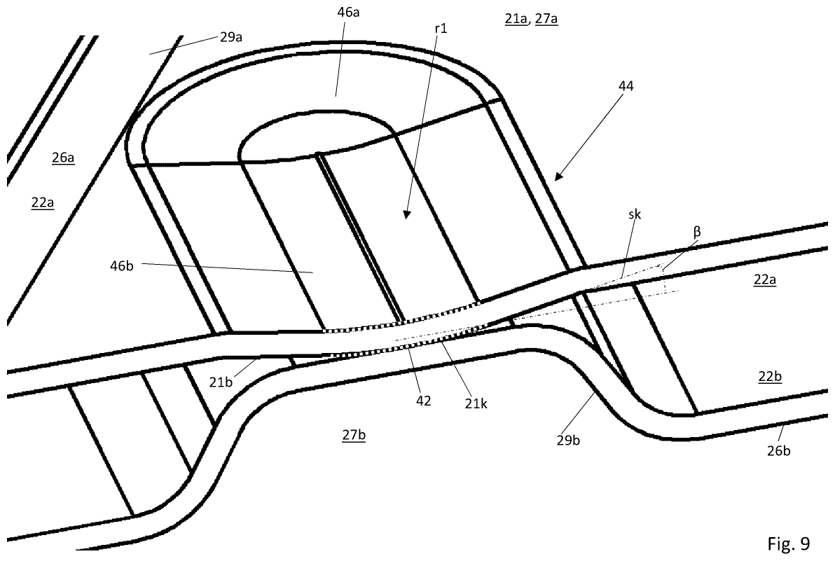

FIG. 9 shows an oblique view of a section of a distribution region of another bipolar plate according to the present disclosure, which is a variant of the section shown in FIGS. 5A and 5B. Here, the spring surface 46 is stepped around the contact surface 42 and has an outer region 46a with a constant pitch sk and an inner region 46b with a pitch designed as a radius r1. The cut edge of the region 46b facing the viewer, including the short straight section in which the cut edge runs along the contact surface 42, is shown dotted both in its lower boundary line and in its upper boundary line in order to emphasize this radius r1.

All of the examples in FIGS. 4 to 9 show that, within a compensating region 35, the webs of one of the separator plates 2a, 2b are each free of materially bonded connections 38 with the second separator plate 2b.

1. A bipolar plate for an electrochemical system, comprising a first separator plate and a second separator plate, which are arranged adjacent to each other in a direction perpendicular to a plate plane of the first separator plate and/or the second separator plate, wherein the first separator plate and the second separator plate each have, adjacent to each other in the direction perpendicular to the plate plane,
a first through-opening for passing a reaction medium through the respective separator plate and a second through-opening adjacent to the first through-opening in the plate plane for passing a temperature control medium through the respective separator plate;
an active region with first structures for guiding reaction medium along an outer flat side of the respective separator plate and second structures for guiding the temperature control medium along an inner side of the bipolar plate; and
at least one distribution or collection region with first structures for guiding the reaction medium between the first through-opening and the active region and second structures for guiding the temperature control medium between the second through-opening and the active region, wherein the second structures of the distribution or collection region have temperature control medium flow channels which are separated from one another by webs,
wherein
the distribution or collection region of the first separator plate and/or the distribution or collection region of the second separator plate have at least one compensating region, and
wherein, in an unassembled state of the bipolar plate, in one, several or all of the at least one compensating region, the webs facing the respective adjacent separator plate between mutually adjacent temperature control medium flow channels are spaced apart from the adjacent separator plate in the direction perpendicular to the plate plane, except that the compensating region has at least one free-standing elastic contact region spaced from an outer edge of the compensating region, in which elastic contact region a section of a web projects in such a way that the section forms a contact surface with the adjacent separator plate.

2. The bipolar plate according to claim 1, wherein the contact surfaces of the elastic contact regions of one separator plate touch web sections of the other separator plate, wherein the contact surfaces of the elastic contact regions and the web sections of the other separator plates that touch the contact surfaces form a fluid barrier in the interior of the bipolar plate.

3. The bipolar plate according to claim 1, wherein for one, several or all of the elastic contact regions, the elastic contact region has an elongated shape, an elongated-rounded shape, a round shape or a free form in a top view of the plate plane of one of the separator plates.

4. The bipolar plate according to claim 1, wherein for one, several or all of the compensating regions, in a top view of the plate plane of one of the separator plates, the compensating region has an area FA and the elastic contact regions of the compensating region have a total area FKges, wherein FKges<0.2 FA.

5. The bipolar plate according to claim 1, wherein for one, several or all of the compensating regions, in a top view of the plate plane of one of the separator plates, the compensating region has an area FA and the contact surfaces of the elastic contact regions of this compensating region have a total area FBges, wherein in a pressed state FBges≤0.05 FA.

6. The bipolar plate according to claim 1, wherein for one, several or all of the elastic contact regions, in a top view of the plate plane of one of the separator plates, the elastic contact region has an elongated shape or a rounded-elongated shape and, in a longitudinal axis (Ll, Lo), extends at an angle α≠0° to a longitudinal axis (Ls, Lsa, Lsb) of the web in the respective elastic contact region, wherein 15°≤α≤90°.

7. The bipolar plate according to claim 1, wherein one, several or all elastic contact regions of one of the separator plates and a web of the distribution or collecting region of the other separator plate extend in orthogonal projection onto the plate plane of the first and/or the second separator plate at an angle γ≤30° relative to one another.

8. The bipolar plate according to claim 1, wherein for one, several or all of the elastic contact regions, in a top view of the plate plane of one of the separator plates, the elastic contact region has an elongated shape or a rounded-elongated shape and in a longitudinal axis extends essentially parallel to a longitudinal axis (Ls, Lsa, Lsb) of a web in the adjacent separator plate.

9. The bipolar plate according to claim 1, wherein a web width (Bs) is constant in the elastic contact region.

10. The bipolar plate according to claim 1, wherein a maximum web width (Bk) in the elastic contact region is at least 30% greater than a web width (Bs) outside the elastic contact region.

11. The bipolar plate according to claim 1, wherein the elastic contact region has a spring surface which extends around the contact surface at least in sections and has a smaller pitch (sk) than an average pitch of a flank of the adjacent web (sf) in the same separator plate.

12. The bipolar plate according to claim 1, wherein the elastic contact region has a spring surface which extends around the contact surface at least in sections and has a pitch (sb) of β≤30° relative to the contact surface.

13. The bipolar plate according to claim 11, the spring surface completely encircles the contact surface.

14. The bipolar plate according to claim 11, wherein the spring surface has, at least in sections, an elongated shape in a top view of the plate plane of one of the separator plates and extends with a longitudinal axis (Lt) substantially parallel to a longitudinal axis (Ls, Lsa, Lsb) of a web of the adjacent separator plate.

15. The bipolar plate according to claim 11, wherein the spring surface extends between two temperature control medium flow channels that are closest to each other in such a way that it connects mutually-facing flank ends of the two temperature control medium flow channels.

16. The bipolar plate according to claim 1, wherein the temperature control medium flow channels of one of the separator plates and the temperature control medium flow channels of the other separator plate extend at least in sections at an angle of 15°≤δ≤90°.

17. The bipolar plate according to claim 1,
wherein within a compensating region, the webs of one of the separator plates are each free of materially bonded connections with the other separator plate.

18. The bipolar plate according to claim 1,
wherein a spring region has at least two regions which have a different pitch relative to the contact surface bounded by the spring region, wherein one of the at least two regions encircles the other completely and/or the at least two regions follow one another in a circumferential manner.

19. The bipolar plate according to claim 1, wherein for one, more or all of the compensating regions of the first separator plate and/or the second separator plate, in the compensating regions, the temperature control medium flow channels, except in the elastic contact regions, are less deep than the outer flank of one or both of the two outermost temperature control medium flow channels.

20. The electrochemical system comprising the bipolar plate according to claim 1, the bipolar plate including the first separator plate, the second separator plate, and at least one MEA.
